(19) United States
(12) Patent Application Publication
(10) Pub. No.: US 2017/0096025 A1
(43) Pub. Date: Apr. 6, 2017

(54) Preapplied Resist Watercolor Paper and Process

(71) Applicant: Julie Comstock, Austin, TX (US)

(72) Inventor: Julie Comstock, Austin, TX (US)

(21) Appl. No.: 14/876,461

(22) Filed: Oct. 6, 2015

(51) Int. Cl. B41M 5/50; B41M 3/00

(52) U.S. Cl. CPC B41M 5/50; B41M 3/005

(57) ABSTRACT

The present invention includes a unique watercolor paper, the method for producing said watercolor paper, and the method for producing a watercolor painting using said watercolor paper. Resists—a clear resist in the form of a clear varnish; and a metallic resist in the form of gold foil—are pre-applied to the watercolor paper as part of the method of manufacture and the process involved. The clear resist is not removed after painting, the foil is applied prior to the clear resist, and neither is allowed to overlap on the watercolor paper. Ideally, both resists interact to form a unified pattern or design.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

Field of the Invention

The present invention relates to resists pre-applied to watercolor paper as part of the method of manufacture and the process involved. More specifically, the instant invention comprises watercolor paper as described herein and the system or method for the manufacture of such watercolor paper using a clear resist in the form of a clear varnish; and a metallic foil in the form of gold or silver foil or the like. Even more particularly, both the clear resist and foil are applied prior to painting, and remains after painting, the foil being applied by stamping before or after the clear resist is printed on the watercolor paper, and neither is intended to overlap each other or the watercolor paper.

Relevant Art

Watercolor is a painting method using paints comprised of water soluble pigments suspended in water. The most common material to which the paint is applied for watercolor paintings is paper, but may also include other media. The white parts of a watercolor painting are most often areas of the watercolor paper or other media left unpainted, so that their white color is preserved as part of the finished work. To preserve these areas, sometime “resists” are used. These can include a variety of materials applied to the paper by the artist prior to painting to protect it from paint. Many art supply manufacturers sell and market liquid resist that can be drawn on with a calligraphy type pens, or painted on with a brush. Common resists used by artists include wax, usually in the form or crayons, and rubber cement glue. However, watercolor paper has not been pre-treated in the prior art so as to have the resist already in place, not has gold foil been used in combination with a resist. To the extent metallic materials have been applied to a paper substrate, they have been put down last on top of the printed surface. Moreover, such pre-treatment would be contrary to the direction of the prior in and non-obvious in reference thereto. The reasons for this include the fact that such pre-placement of resists restrict the unfettered creativity of the artist by, in effect, limiting the discretion of the artist in terms of the placement of resists and in terms of what types of resists will be used. More technical reasons are explored in reference to the detailed description of the invention.

### SUMMARY OF THE INVENTION

The instant invention includes watercolor paper with a pre-applied resist and a system or method for the manufacture thereof. In the preferred embodiments described, a clear resist in the form of a dear varnish is employed as well as a metallic foil in the form of gold or silver foil, or other colors. By using and pre-applying both clear varnish and gold foil, the invention achieves many unique effects. First, the clear varnish resist co-acts with the watercolor paint differently than the foil. Although the paint rolls off and won't stick, the varnish is often stained slightly leaving a light tone from the color that came in contact with it. Also the watercolor may seep at the edges of the resist or bleed thereunder. Further, some traditional resists are removed after the paint is applied, whereas the varnish used in the invention remains. In contrast to the varnish resist, the metal foil does not tint and any seepage thereunder would not show since the foil blocks same. By using both, the invention achieves an unexpected and highly original look prized by artists and consumers. Second, the varnish is slightly raised above the paper surface, whereas the foil is slightly depressed into the paper. As further explained below, this once again leads to unique effects once painted. Third, the method of the invention allows the artist to see, work with, and design around the resist and foil at the same time and is the only one that allows both to be placed before the painting begins.

### BRIEF DESCRIPTION OF THE DRAWINGS

The novel features believed to be characteristic of this invention are set forth with particularity in the appended claims. The invention itself, however, both as to its organization and method of operation, together with further object and advantages thereof, may best be understood by reference to the following, description taken in connection with the accompanying drawings in which:

FIGS. 1A, 1B, and 1C depict a schematic view of a sheet of watercolor paper with pre-applied resist and foil in accordance with the invention.

FIGS. 2A, 2B, and 2C depict a second schematic view of a sheet of watercolor paper with pre-applied resist and foil in accordance with the invention.

FIGS. 3A, 3B, and 3C depict a third schematic view of a sheet of watercolor paper with pre-applied resist and foil in accordance with the invention.

FIG. 4 depicts a view of the watercolor paper/page illustrated in FIG. 2C, after water color paint has been applied in a simple schematic pattern in accordance with the invention.

FIGS. 5A, 5B, and 5C depict a fourth schematic view of a sheet of watercolor paper with pre-applied resist and foil in accordance with the invention.

FIGS. 6A, 6B, and 6C depict a fifth schematic view of a sheet of watercolor paper with pre-applied resist and foil in accordance with the invention.

### DESCRIPTION

As previously discussed, the preferred resist and foil for the purposes of the present invention are varnish and gold foil. In general, varnish is used to form a transparent protective finish or film, and is primarily used in wood finishing. It is typically formed by combining a drying oil, a resin, and a thinner or solvent. The resulting finish is usually glossy but “flatting” agents may be added to produce a satin or semi-gloss finish. In the printing process used to prepare the watercolor paper of the invention, varnish is used like an ink without pigment. Consequently, it requires is own printing unit on press. Metallic foils can also be applied as part of the commercial print process (“foil stamping”), which involves the application of metallic foil, often gold or silver, to paper. The printing process uses heat and pressure combined with a metallic paper (foil) to create graphic designs. Foil stamping is sometimes called dry printing as no “wet” ingredients (such as ink) are used for printing purposes.

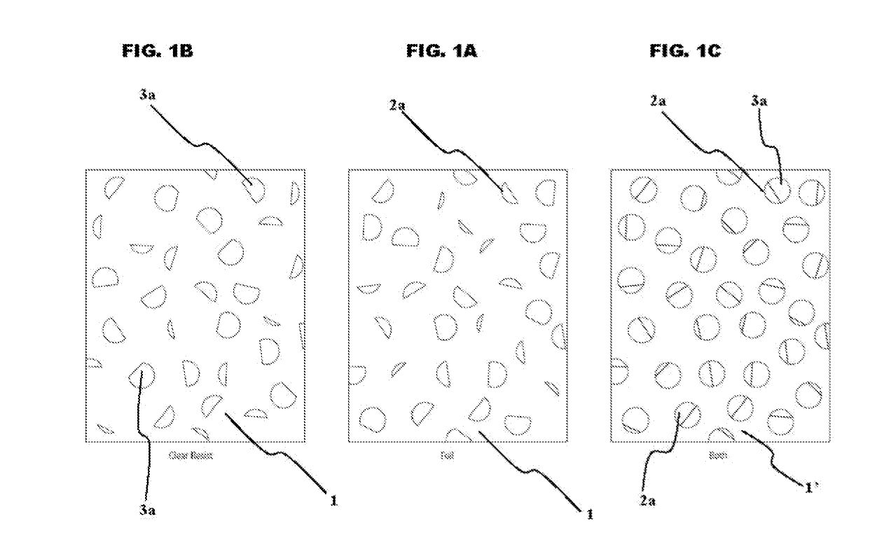

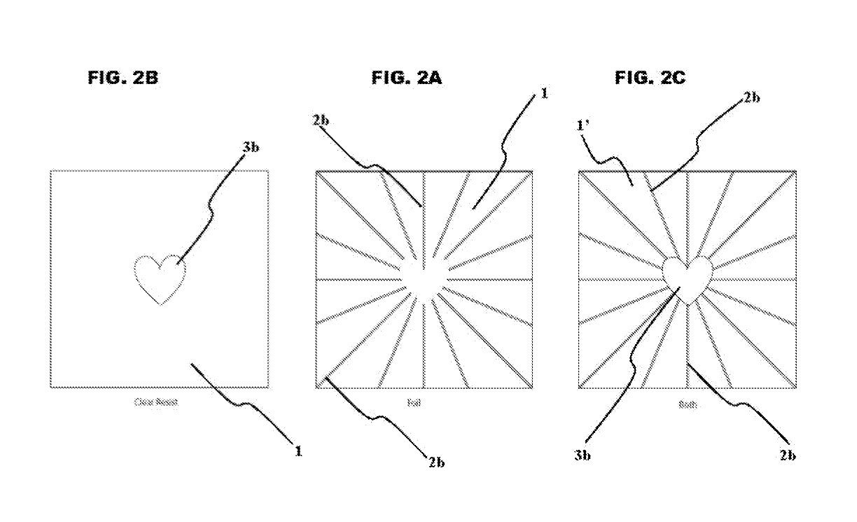

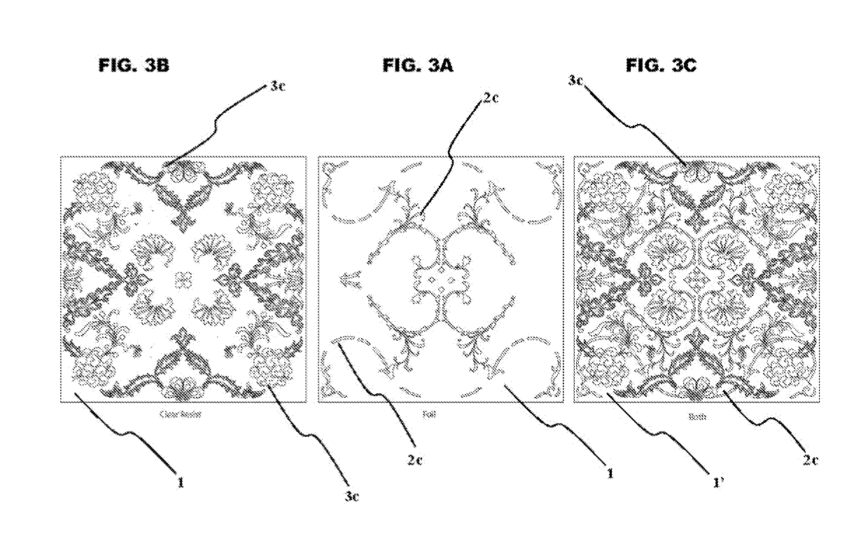

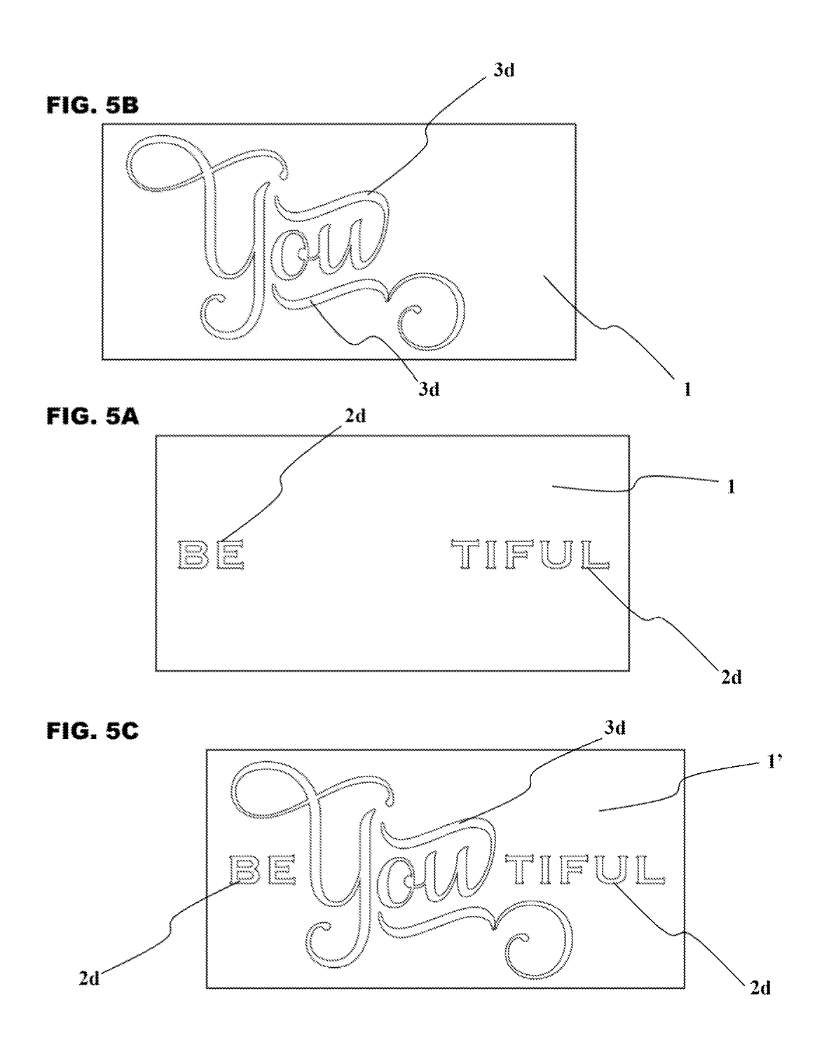

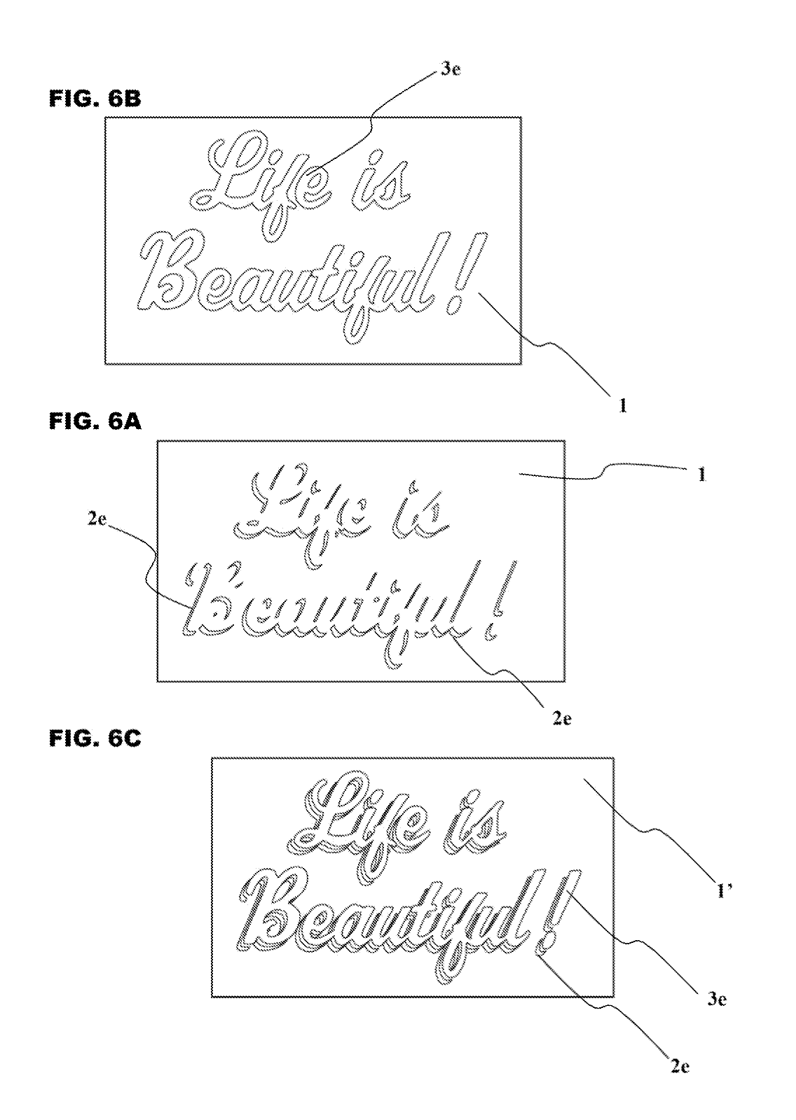

In the present invention these two printing processes are used in tandem to produce a unique artistic product. In the first step, as illustrated in reference to the watercolor paper 1 shown in FIGS. 1A, 2A, 3A, 5A, and 6A a foil product (preferably gold foil) is applied using known printing techniques to create desirable metallic patterns and shapes 2a, 2b, 2c, 2d, 2e on paper 1. Clear resist (preferably varnish) can also be applied (without pre-placement of foil) using known printing techniques to create desirable clear resist patterns and shapes 3a, 3b, 3c, 3d, 3e as illustrated in FIGS. 1B, 2B 3B, 5B, and 6B; however, the second step of the invention involves the application of the clear resist patterns and shapes 3a, 3b, 3c, 3d, 3e to the previously foil printed paper (as illustrated in FIGS. 1A, 2A, 3A, 5A, and 6A) without overlapping, the previously applied foil so as to arrive at the more complex combined patterns illustrated in FIGS. 1C, 2C, 3C, 4C and 5C on watercolor paper with pre-applied resist 1′.

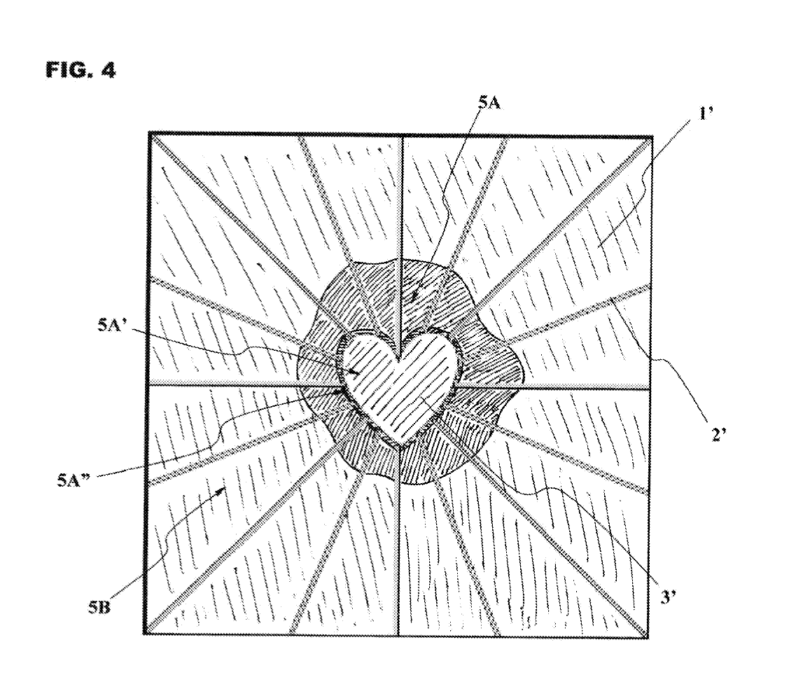

The third step of the invention can be reserved for the individual artist, end user and/or consumer purchasing/using, the pre-applied resist and foil paper of the invention. It involves painting a desired pattern or design 4 on the paper 1′ using water color paints (indicated generically as areas 5A, 5B, which will create a very pleasing and unusual individual work of art which will vary with each new creation. In this process, the clear varnish 3b resists the paint 5A, 5B differently than the foil 2b. Although the paint 5A roils off and won't stick to either the foil 2b or the varnish 3b, the resist is often stained slightly leaving a light tone from the color (such that the once white clear resist 3b area now is indicated to have a lighter version 5A′ of color 5A. Any red tone and most deep tones particularly affect the varnish 3b, tinting it slightly as indicated in FIG. 4. Traditional resists are removed after the paint 5A, 5B is applied leaving just the paper 1′ behind, so this would not be an effect created with traditional resists. In contrast, the metal foil 2b doesn't tint at all but remains true. By using both, the invention achieves an unexpected look.

Another feature of the invention produced in the second step outlined above, is that the clear resist varnish patterns and shapes 3a. 3b, 3c, 3d, 3e are slightly raised above the paper surface whereas the foil resist patterns and shapes 2a, 2b, 2c, 2d, 2e are slightly depressed into the paper 1′. This means that the paint can pool and run along the edges of the clear varnish resist of patterns and shapes 3a, 3b, 3c, 3d, 3e so as to leave a darker tone 5A″ (as illustrated in FIG. 4) next to its edge and rolling around the printed design 3b in interesting ways. However, paint 5A, 5B doesn't pool next to the depressed foil resist 2b leaving the control of those areas with the artist. Designs and shapes 2a, 2b, 2c, 2d, 2e, 3a, 3b, 3c, 3d, 3e are created with this difference in mind to achieve unique effects once painted.

The method of the invention lets the artist see, work with and design around both foils 2a, 2b, 2c, 2d, 2e and clear resists 3a, 3b, 3c, 3d, 3e at the same time. In the traditional (prior art) method, the clear resists would be drawn or painted on the paper, and then the paper would be painted with water color. After the paint dried the clear resist coatings would be removed and the metallic foil would only then be added. The metallic foil comes last in the traditional prior an method for a couple of reasons. First, the foil can't go over the resist. Not only is the resist raised (whereas the foil is pressed into the paper), but clear resists in the prior art are removed after the paper is painted. If the foil were on top, it would be removed with the resist. Second, in accordance with prior art, if the kid were placed first there would be two issues: any resist going over the top of the foil would cloud the metallic foil if left, and if pulled off would pull the foil off in the process. The method disclosed herein is the only one that allows both the resist and foil to be placed before the painting begins. It also allows the clear resist to remain rather than being removed.

In terms of production, the method (and the product) of our invention requires very precise application as clear resist clouds the foil, but the foil can't go over the top of the varnish because it is raised and the foil is set into the paper. To make this work, it is necessary to cut the designs so that any overlapping areas are deleted. With particularly intricate designs, this is quite time consuming even using a computer. However, in this area as in many others, it should be clear that numerous changes and variations can be made without exceeding the scope of the inventive concept outlined. Accordingly, it is to be understood that the embodiment(s) of the invention herein described is/are merely illustrative of the application of the principles of the invention. Reference herein to details of the illustrated embodiment(s) is not intended to limit the scope of the claims, which will recite those features regarded as essential to the invention.

1. A method for producing watercolor paper with a pre-applied resist and a metallic foil, comprising:
stamping metallic foil on watercolor paper so as to form a first selected pattern of metallic resist prior to applying watercolor paint or clear resist to said paper;
printing a clear resist on watercolor paper so as to form as second selected pattern of clear resist prior to applying watercolor paint to said paper; and
wherein neither of said resist patterns overlay or cross each other.

2. The method of claim 1, wherein at least one of
said metallic foil is gold foil,
said clear resist is varnish,
said first selected pattern and said second selected pattern are selected to form an overall selected pattern incorporating both the first selected pattern and the second selected pattern,
said gold foil forms a surface below the ambient surface of the paper,
said varnish forms a surface above the ambient surface of the paper,
said varnish is tintable by watercolor paint applied to it, and
said varnish having a darker border of watercolor paint around its border when watercolor paint is applied to said varnish and its said border.

3. A method for producing a watercolor painting, comprising:
stamping a metallic foil on watercolor paper forming a first selected pattern of metallic areas prior to applying watercolor paint;
printing a clear resist on watercolor paper forming a second selected pattern of clear resist areas;
painting said paper with water color paint in a third selected pattern which may overlie some of said clear resist areas;
retaining said clear resist after painting; and
wherein neither of said first and second patterns overlie or cross each other.

4. The method of claim 3, wherein at least one of:
said first selected pattern and said second selected pattern are selected to form an overall pattern incorporating both the first selected pattern and the second selected pattern,
said metallic foil being gold foil which is applied so as to farm a surface below the ambient surface of the paper,
said clear resist being varnish which is applied so as to form a surface above the ambient surface of the paper,
said varnish being tintable by watercolor paint being applied to it, and
said varnish having a darker border of watercolor paint around its border when watercolor paint is applied to said varnish and its said border.

5. A watercolor paper with a pre-applied resist and a foil, comprising:
a metallic foil stamped on said paper so as to form a first selected pattern of metallic areas, and a clear resist printed on said paper so as to form a second selected pattern of clear resist areas;
said foil and resist pattern areas do not overlay or cross each other; and
said first selected pattern areas and said second selected pattern areas form an overall unified selected pattern merging both pattern areas.

6. The method of claim 1, wherein at least one of:
said metallic foil is gold foil which is stamped so as to form as surface below the ambient surface of the paper,
said clear resist is varnish which is printed so as to form a surface above the ambient surface of the paper,
said varnish is tintable by watercolor paint being applied to it, and
said varnish having a darker border Of watercolor paint around its border when watercolor paint is applied to said varnish and its said border.
